(19) United States
(12) Patent Application Publication
(10) Pub. No.: US 2010/0057261 A1
(43) Pub. Date: Mar. 4, 2010

(54) METHOD AND DEVICE FOR PROCESSING AND STORING DATA

(75) Inventors: Olivier Courrieu, Paris (FR); David Pohunek, Paris (FR); Bruno Vidal, Paris (FR)

Correspondence Address: LEYDIG VOIT & MAYER, LTD, 700 THIRTEENTH ST. NW, SUITE 300, WASHINGTON, DC, 20005-3960, US

(73) Assignee: GDF SUEZ, Paris (FR)

(21) Appl. No.: 12/376,132

(22) PCT Filed: Aug. 7, 2007
(86) PCT No.: PCT/FR2007/051796

§ 371 Date: Nov. 4, 2009

(30) Foreign Application Priority Data
Aug. 10, 2006 (FR) 0653350

(51) Int. Cl. G05D 7/00

(52) U.S. Cl. 700/281

(57) ABSTRACT

A method and a device for processing and storing data generated in a fluid flow station, the data being read and put into a volatile memory allocated to a communicating module of the flow station. The data are analyzed according to predetermined relevancy criteria to select data corresponding to a type of event, and the selected data are analyzed according to a redundancy criterion to detect data having the same value during two successive readings. The data having a value unchanged in relation to the value of the previous reading are replaced by a mark and the data thereby compressed are stored in a non-volatile memory.

### FIELD OF THE INVENTION

The present invention relates to a method for processing and storing representative data for the operation of an apparatus or an installation, as well as to a device for processing and storing such data.

The present invention relates to optimization of the processing and storing of data enabling one to monitor the operation of one or more apparatus or installations considered hereafter as a “fleet of apparatus.”

Presented here as a non-limiting example of an application of the process and device of the invention is a fleet of household apparatus for filling a tank with natural gas, and more particularly the application to the filling a natural gas tank of an automobile.

### BACKGROUND

Previously, automobiles whose internal combustion engine uses natural gas as fuel had to go to a service station equipped with a natural gas station, just as vehicles whose internal combustion engine uses gasoline or diesel similarly must do.

Henceforth, it is possible for private houses connected with the natural gas supply network to be equipped with a household filling apparatus, enabling one to personally fill the natural gas tank of the vehicle of the resident of the house. The supply of natural gas then occurs on the same basis as that of the natural gas used for heating and the kitchen. The difference in equipment consists mainly in a compressor making it possible to introduce the natural gas into the tank of the vehicle up to a predetermined pressure greater than that with which the natural gas arrives at the furnace or cooking station in the kitchen.

FIG. 1 of the appended drawings diagrammatically represents a household installation with a delivery station or filling apparatus to which the present invention can be applied. The natural gas arrives at exterior box 1, which has a main meter and is then distributed in two pipes, one of which routes the natural gas towards household items such as boiler 2, a cooking plate or a water heater, and the other of which the pipes route the natural gas to sub-meter 3 and then, toward a household filling apparatus, which has individual compressor 4 intended for putting the natural gas at the pressure necessary for filling the tank of automobile V, and communicating module 5, making possible direct or remote collection of data concerning operation of the household filling apparatus to which, for example, the quantity of natural gas delivered can be added.

The execution of this concept results in a rather large number of filling apparatus to be overseen and maintained.

To enable the natural gas supplier and/or the household filling apparatus supplier to remotely monitor the operation of the fleet of household filling apparatus and to deduce from that, for the short term, as well as for the long term and for troubleshooting, appropriate maintenance or repair steps, the filling apparatus can advantageously be equipped with means configured for generating data representative of measured values, of parameters and of many other characteristics, and make these data available for remote reading, by telecommunication or radio, or for local reading using an apparatus carried by mobile personnel.

The acquisition of data representing measurement values or data representative of other characteristics of the operation of a fleet of household filling apparatus, the transmission of these data by a cable link or by mobile memories (for example, discs or so-called USB key drives) and the transmission of these data to a central processing station, as well as the utilization or processing of these data are large-scale activities because of the very large number of data to be processed, but are also activities that are generally subject to particular constraints depending on the chosen field of application, requiring specifically adapted solutions.

In effect, the filling apparatus and the means to be provided for reading the data are housed in casings, which are, to varying degrees, sealed and which are subject to sometimes rather extensive climatic variations. Simple and sturdy means therefore need to be provided. At the same time, since their number is rather large, it is necessary to provide inexpensive means lending themselves to utilization by a simple process. Furthermore, the large number of filling apparatus to be provided will lead to a very large number of data to be processed by the remote meter reading central platform.

For applications involving the use of hard disks and for applications involving the use of low-capacity memories such as those incorporated in “chip cards”, also called “smart cards,” it has been possible to find solutions by optimizing the utilization of the storage capacity by compression of the data, for example.

However, for an application in which the simplicity of the means is a front-line concern and in which the cost and size of the memory components must be minimized, data compression alone would not provide the anticipated success.

### SUMMARY OF THE INVENTION

The aim of the invention is to propose a process and/or means making it possible to process acquired data by simple means, which have to be able to operate under sometimes severe conditions, and which are executed or implemented using low-cost means. Furthermore, it must be possible to process and store the data at a relatively low frequency, while permitting the detection of any event, as well as the reconstitution of the scenario a posteriori.

The aim of the invention is attained with a process for processing and storing of data generated in a fluid delivery station, the data being read and placed in a volatile memory assigned to a communicating module of the delivery station.

According to this process, the data are then analyzed according to predetermined relevance criteria to select from them the data corresponding to a type of event, the selected data are analyzed according to a redundancy criterion to detect the data having the same value during two successive readings, the data whose value is unchanged with respect to the value of the previous reading are replaced by a mark, and the data thus compressed are stored in a non-volatile memory.

The aim of the invention is also attained with a device for processing and storing data generated in a fluid delivery station.

### BRIEF DESCRIPTION OF DRAWING FIGURES

FIG. 1 diagrammatically represents how a device of the invention can be integrated, for example, in a gas distribution installation, and

FIG. 2 diagrammatically represents the relationship between a filling apparatus whose operation is to be overseen by a process and a device of the invention.

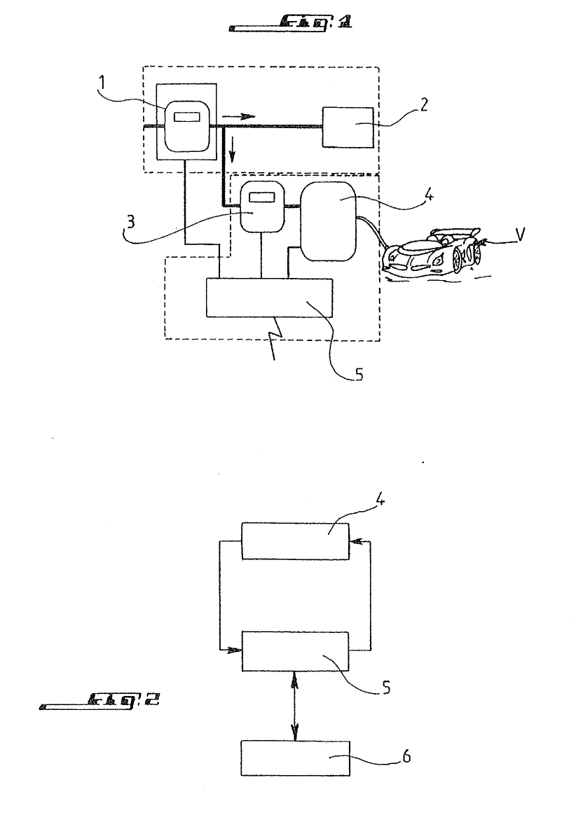

### DETAILED DESCRIPTION

The solution proposed by the present invention is based on the following thought: the measurement values and other items of information representative of the operation of the household filling apparatus are transmitted to the communicating module by a serial link from a standard RS232 port. In regular intervals, for example, each second, the communicating module sends a request to the filling apparatus to collect operation data, such as measured values, operation parameters, indications of operating status and possible indications of operating error. The filling apparatus responds by sending a data packet containing all the raw data regardless of the state of these data. The filling apparatus therefore operates, with regard to data processing, as slave.

All the data transferred from the filling apparatus to the communicating module are stored in the communicating module in different memories of the module.

These memories consist in part of non-volatile memories (for example, a flash memory), and for the rest, of volatile memories (for example, a RAM memory). The RAM and flash memories, with their respective characteristics, are the most widespread in electronics. Hard disks, especially those with small dimensions, are more expensive and more fragile. Considering the limits in terms of number of writings and the cost of flash memories, it is RAM memory that will be used to temporarily store the responses from the filling apparatus. The data are stored in a database in which a response number is associated with each response D(t). This number is increased by one unit for each new response. It is, therefore, unique and makes it possible to identify, in time, the responses contained in memory.

Non-volatile memories have the main characteristics that the stored information items are not lost with a power cut-off, but that the number of writings to memory is limited. Furthermore, since the writings to memory are physical modifications of each cell of the memory, wear and tear effectively occurs with each writing.

In contrast to this, volatile memories are characterized by the loss of stored information in case of a power cut-off, but they support a quasi-infinite number of writings.

There exist non-volatile memories other than flash memory. However, non-volatile memories such as hard disks require an operating environment which is sometimes rather burdensome and rather restraining, which is contrary to the operating conditions of stations, such as a household filling station whose characteristics of operation and circumstances of installation correspond, rather, to those of an on-board environment in which the size and cost of the components are optimized.

Furthermore, when one compares the cost of flash memory with that of RAM memory, the cost of flash memory is clearly greater and, therefore, in that case, again requires maximum optimization of its utilization.

These material conditions resulted in the choice, to solve the problem posed for the invention, of the data to be stored and processed, in the sense of a selection which can be made concerning the data to be kept as a function of the importance given to them. Thus, as will be explained hereafter, the communicating module receives all data, stores them temporarily, awaiting a decision as to the need to sort them and store them definitively. In effect, like any central acquisition station, mobile or on-board in particular, the communicating module has limited storage space. Furthermore, this also implies having to regularly clear some of the data stored temporarily in the volatile memory.

Furthermore, the solution has been drawn up in such a way as to optimize the following criteria:
cost and size of the memory components used,
period between two clearings, therefore cost of the clearing,
risk of data loss by power cut-off.

The dialogue between the household filling apparatus and the communicating module occurs by a standard RS232 serial link. The protocol governing the exchanges between the apparatus and the module is executed according to the principle that the communicating module is the master of the exchange and the filling apparatus is the slave.

Upon request of the module, and assuming that the link between the module and the filling apparatus is correct, the filling apparatus sends all of its n data items at time t:
d1(t),
d2(t),
dn(t).

According to this protocol, the filling apparatus sends a packet of raw data, D(t)=[d1, d2, . . . , dn] at time t to the communicating module. The dialogue occurs periodically, and the period is determined depending on the later use of the data. For the application described in the context of the present invention, the period of one second is selected.

In a first step, the data received from the filling apparatus, that is to say, the responses of the filling apparatus to the request of the communicating module, are stored so that they can be analyzed and processed in an appropriate manner. The processing of the data is present in the form of a combination of filtering and compression. In effect, even with only one writing completed per second, approximately 150 million writings accumulate in five years of operation. Independently of the matters of memory size and the costs connected with the processing of such a quantity of data, it is necessary to know how to handle a superabundance of data which, because of the quantity, risks hiding the information that is truly useful, as mentioned above, for establishing appropriate maintenance and follow-up of the operation of different apparatus.

So the process of the invention provides as first step a filtering of the data to be processed. In effect, as described above, leaving the data in a volatile memory presents the risk of losing them during a power cut-off. Since non-volatile memories, particularly flash memories, are limited in terms of the number of writings and also in terms of storage space, it is a matter of writing the least possible amount of unnecessary data to the non-volatile memory. Furthermore, to be able to space out the clearings of data from the communicating module, so that it is possible to limit the costs of clearing, it is necessary to be able to cover a rather long period. It is therefore necessary to filter the data that are to be kept to the maximum extent, that is to say, only the most relevant data should be kept.

A first filtering operation is executed using the facts that an apparatus can have different steps in its operation and one need not take into account all the steps to oversee the operation of the apparatus. Thus, for a household filling apparatus, five events around the compressor of each of the delivery stations have been distinguished:
starting the compression,
compression in progress for an uneven number of hours,
stopping of the compression,
error detected concerning the compressor, and
regeneration of the compressor.

These events represent the operation steps considered necessary to oversee, contrary to the other steps. The events are detected by analyzing the successive responses of the filling apparatus, if they contain this type of information. For example, regeneration is detected when the data item “regeneration of the compressor” switches from 0-1.

For each type of event, a window of time is determined shortly before the beginning of the event and shortly after the beginning of the event.

For this purpose, the data continually generated and stored in the volatile memory are read in such a way that they can be scrolled in a reading window so that it is possible to identify the beginning of the event, and the window of time can be placed with respect to this event beginning.

Of all the data in the volatile RAM memory, only the data received during this window of time are considered.

Furthermore, for each type of event, certain information items are not relevant or are only relevant at a precise instant of the window of polling of the event: for example, the ambient temperature is only relevant at the beginning and end of a window in case of starting of compression. The limitation to relevant data for each type of event constitutes a second degree of filtering.

A third degree of filtering is applied by removing all redundant data. In effect, writing a value takes more storage space than inserting a simple mark indicating that the value is the same as that of the previous response. So when the comparison between a data item and the previous data item shows that there is no change in values, a simple mark is inserted, indicating that the value is the same as that of the previous response.

In summary, when an event is detected, the responses of the household filling apparatus are always stored in the database in RAM memory until the window of time defined for this event is finished. Only then are the necessary data extracted from the base, and a new file, still in the form of a database, is created. The new file contains only the minimum amount of data necessary for understanding the operation of the filling apparatus during the given window of time.

The responses of the filling apparatus are stored in a volatile RAM memory according to a FIFO structure, “First In First Out,” that is to say, when all the storage space dedicated to these responses is occupied, it is the oldest information that is erased to permit the saving of a new response. Furthermore, the space dedicated to the responses of the household filling apparatus, as well as the windows of time, have been determined so that during an event, the past information items are still in volatile memory when the window of time is finished.

The table hereafter shows as an example, for the starting event, the data to be written in flash memory for a window of time ranging from five seconds before the typical time for the event and to 175 seconds after the event.

| | Time | | | | |
|---|---|---|---|---|---|
| Data | T − 5 | T−i | T0 | T + i | T + 175 |
| Air Sensor | YES | Yes, if | Yes, if | Yes, if | Yes, if |
| Valid Flag | | change | change | change | change |
| Fan ON | YES | Yes, if | Yes, if | Yes, if | Yes, if |
| | | change | change | change | change |
| Combi-valve | YES | Yes, if | Yes, if | Yes, if | Yes, if |
| ON | | change | change | change | change |
| Motor ON | YES | Yes, if | Yes, if | Yes, if | Yes, if |
| | | change | change | change | change |
| Unit Is Filling | YES | Yes, if | Yes, if | Yes, if | Yes, if |
| | | change | change | change | change |
| Gas Sensor | YES | Yes, if | Yes, if | Yes, if | Yes, if |
| Valid Flag | | change | change | change | change |
| Inlet Pressure | YES | Yes, if | Yes, if | Yes, if | Yes, if |
| Is ON | | change | change | change | change |
| HPT Valve | YES | YES | YES | YES | YES |
| LPT Valve | YES | YES | YES | YES | YES |
| Ambient | YES | NO | YES | NO | YES |
| Temperature | | | | | |
| Value | | | | | |
| Fill Time | YES | NO | YES | NO | YES |
| Seconds | | | | | |
| Fill Time | YES | NO | YES | NO | YES |
| Seconds | | | | | |
| Total Fill | YES | NO | YES | NO | YES |
| Seconds | | | | | |
| 350 DC | YES | YES | YES | YES | YES |
| Voltage | | | | | |
| Motor Speed | YES | Yes, if | Yes, if | Yes, if | Yes, if |
| | | change | change | change | change |

Once the most relevant data have been selected from all the data received from the filling apparatus, the file containing these selected data is compressed by an application in the communicating module. This compression can be executed with a software of the “gzip” type operating under Linux.

When the file containing the selected data is compressed, it is stored in non-volatile memory, in this case in flash memory, in a FIFO structure. Thus, filtered and compressed, the selected data occupy little space. The occupation in flash memory depends mainly on the number of events. And if there are many events between two data clearings, the information concerning the oldest events are the ones that will be lost. This constitutes an accepted choice. Nevertheless, the non-volatile memory is usually sized to contain all data sorted between two readings.

In summary, the process of the invention uses the following steps:

numbering of responses of the filling apparatus,

storing of responses of the apparatus in volatile memory of the RAM type, organized in the form of a FIFO register,

definition of events, that is to say, of important steps,

definition of windows of time,

definition of relevant data,

management of the redundancy of the data values,

applicative compression, in this case, compression applied on the communicating module.

storing of the filtered and compressed data in non-volatile flash memory organized in the form of a FIFO register.

The aim of the invention is also attained with a device for processing of data generated in a fluid delivery device, which has, besides means for reading of the generated data, in a communicating module of the delivery station, a volatile memory for storing the data that have been read, non-volatile memories for storing selection criteria, at least one comparator for making data selections according to predetermined relevance and redundancy criteria, and a non-volatile memory for storing the selected data.

According to some advantageous embodiments of the invention, the non-volatile memory assigned to the communicating module of the delivery station, for placing the data that have been read, is organized in the form of a queue register, that is to say, “first in, first out” and/or the non-volatile memory for storing the selected data is organized in the form of a queue register, that is to say, “first in, first out.”

FIG. 2 of the appended drawings diagrammatically represents the relationship between a filling apparatus whose operation is to be overseen using a process and a device of the invention and a communicating module, which collects and processes and then stores the data that are to be kept.

In FIG. 2, it is seen more particularly that the household filling apparatus has individual compressor 4 connected with communicating module 5. Communicating module 5 polls a memory associated with compressor 4 (arrow on the right), and the latter sends all the data to communicating module 5 (arrow on the left). Once all the data thus received have been filtered and compressed as described above, communicating module 5 is ready for transmitting the data that are to be kept, according to a particular protocol, to platform 6 configured for utilizing the data that have been acquired and selected. The transmission between communicating module 5 and platform 6 can take place in any appropriate technical manner, particularly by telecommunication or by a mobile person who collects the data using removable memories such as discs or said USB Key drives.

1. A method for processing and storing data generated in a fluid delivery station by a data processing platform, including a communication module, the method comprising:
reading the data and placing the data in a volatile memory assigned to the communicating module of the delivery station,
polling the delivery station periodically by the processing platform,
determining a window of time before beginning of an event having data sought for processing and storage, and
after beginning of the event, processing and storing only the data received during the window of time.

2. The method according to claim 1, including:
analyzing the data according to predetermined relevance criteria
selecting from the data only the data corresponding to a type of event,
analyzing the data selected according to a redundancy criterion to detect data having the same value during two successive readings of data,
replacing the data having a value that is unchanged with respect to the value of the data in the previous reading with a mark, thereby compressing the data, and
storing the data, after compressing in a non-volatile memory.

3. The method according to claim 1, including storing the data generated in the delivery station in the volatile memory assigned to the communicating module of the delivery station in the order in which the data are read.

4. The method according to claim 2, including storing the data, after compressing, in the non-volatile memory of the communicating module of the delivery station in the order in which the data are placed in the non-volatile memory.

5. The method according to claim 1, wherein the communicating module polls the delivery station approximately once per second.

6. The method according to claim 1, including reading and placing the data generated in the delivery station, in the volatile memory assigned to the module, with a frequency of approximately 1 Hz.

7. The method according to claim 1, including numbering the data generated in the delivery station by the module, for each response before being placed in the volatile memory.

8. A device for processing data generated in a fluid delivery station comprising:
means for reading the data generated, in a communicating module of the delivery station;
a volatile memory for storing the data read;
non-volatile memories storing selection criteria;
at least one comparator for selecting data according to predetermined relevance and redundancy criteria; and
a non-volatile memory storing the data selected.

9. The device according to claim 8, wherein the volatile memory for storing the data that have been read is organized as a queue register.

10. The device according to claim 8, wherein the non-volatile memory for storing data selected is organized as a queue register.

11. The device according to claim 9, wherein the non-volatile memory for storing the data selected is organized as a queue register.
